(19) United States
(12) Patent Application Publication
(10) Pub. No.: US 2003/0124996 A1
(43) Pub. Date: Jul. 3, 2003

(54) Tuner comprising a selective filter

(76) Inventors: Sebastien Amiot, St. Aubin S/ Mer (FR); Jean-Marc Paris, Giberville (FR); Lakhdar Zaid, Caen (FR)

Correspondence Address: PHILIPS ELECTRONICS NORTH AMERICAN CORP, 580 WHITE PLAINS RD, TARRYTOWN, NY, 10591, US

(21) Appl. No.: 10/301,227

(22) Filed: Nov. 21, 2002

(30) Foreign Application Priority Data
Nov. 27, 2001 (FR) 0115312

(51) Int. Cl. H04B 1/18

(52) U.S. Cl. 455/131; 455/150.1; 455/179.1

(57) ABSTRACT

The invention relates to a tuner for converting a RF signal (110) into an IF output signal (202), said tuner comprising a mixer (111) for generating a first IF signal (201), processing means (114) for filtering said first IF signal (201) so as to generate said IF output signal (202). The tuner according to the invention is characterized in that said processing means (114) comprise:

a voltage follower circuit (203) receiving said first IF signal (201) for generating a second IF signal (204) at a low impedance,

control means (205) for controlling the value of the bias current of said voltage follower circuit (203),

a filter (206) having the double resonance frequency for filtering said second IF signal (204) and generating said IF output signal (202).

The tuner according to the invention has a strong selectivity for eliminating the residues of frequency components of channels adjacent to the selected channel, as well as a linear frequency response.

### FIELD OF THE INVENTION

The invention relates to a tuner for converting a RF (radio frequency) signal into an IF (intermediary frequency) output signal, said tuner comprising a mixer for generating a first IF signal, processing means for filtering said first IF signal so as to generate said IF output signal.

The invention finds numerous applications in systems for receiving RF signals.

### BACKGROUND OF THE INVENTION

The role of a tuner is to select a data signal centered at a certain frequency in a RF input signal and to convert the selected signal into an IF output signal. The data signal defines a frequency channel. Tuners are currently used in radio and television apparatuses or, more generally, in apparatuses processing modulated input signals conveying multimedia data.

FIG. 1 describes the different functional blocks of a tuner known from the prior art.

The tuner comprises filtering means 101 receiving a RF signal 102 and supplying a first filtered signal 103. The filtering means 101 effect an impedance and level matching with the receiving means 104 (antenna, cable . . . ), and a selective filtering in the spectrum of the signal 102 around the frequency spectrum of the desired channel. The filtered signal 103 is amplified by an amplifier 105, such that the amplitude of the IF output signal 106 remains constant regardless of the level of the RF signal 102. To this end, control means 107 are provided with which the automatic gain control applied to the filtered signal 103 by the amplifier 105 is realized. The filtering means 108 effect a filtering operation on the amplified signal 109 so as to accentuate the selectivity of the desired channel for generating an output signal 110. Particularly, the filtering means 108 provide the possibility of suppressing the picture frequencies in the frequency spectrum. The tuner also comprises a mixer 111 for converting the RF input signal 110 into an IF output signal 112. The mixer 111 receives the output signal 113 generated by a voltage-controlled oscillator 117. The mixer 111 multiplies the input signal 110 by said output signal 113, involving a frequency shift on the signal 110. The IF signal 112 having a frequency which is equal to the difference between the frequencies of the signals 113 and 110 is filtered by the filtering means 114 so as to attenuate the RF residues and generate a filtered IF signal 115. Particularly, the filtering means 114 attenuate the residual frequencies from the mixer 111, as well as the residual frequencies from channels which are adjacent to the desired channel and have not been completely suppressed by the filtering means 101 and 108. The filtered IF signal 115 is subsequently amplified by means of the amplifier 116 for generating said IF output signal 106. Control means 118 of the phase-locked loop type provide the possibility of controlling the central frequency of the filtering means 101 and 108, and ensure the stability of the phase of the IF signal 112 by supplying a signal having a variable voltage level to the oscillator 117.

U.S. Pat. No. 6,070,061 describes a tuner for converting a RF signal into an IF signal. This patent provides selective filtering means constituted by the cascade arrangement of two selective filters for forming a bandpass filter applied on the IF signal.

These selective filtering means have a certain number of limitations, particularly when the RF spectrum comprises channels having frequencies which are proximate to each other and whose levels vary within large ratios.

Due to the large-scale transmission of digital television services and considering that the range of the RF spectrum is limited, the frequency channels relating to each service are very near to each other. In this context, the filtering means described in the prior-art document do not allow a precise selection of a particular channel. Indeed, the selectivity of these filtering means is not sufficiently large, on the one hand, because the principal lobe of the frequency response is not sufficiently pronounced, but, on the other hand, also because the secondary lobes have a high amplitude. Frequency components of adjacent channels are therefore not suppressed by the filtering means. This leads to an IF signal of poor quality, i.e. to a poor picture quality when a video signal is concerned.

Moreover, these digital channels constituting the RF spectrum are currently transmitted via a digital modulation technique, for example, of the QAM type. This type of modulation allows the tuner to have a very low gain variation (referred to as “tilt”) on the frequency range of the channel to be selected. Typically, a maximum variation of 0.5 dB is allowed for a channel having a width of 6 to 8 MHz. The selective filtering means described in the prior-art document cannot satisfy the requirements of this modulation type in so far as they have a high tilt on a channel having a width of 6 to 8 MHz, which results in a poor reception of the desired channel and/or a poor picture quality when a video signal is concerned.

### OBJECT AND SUMMARY OF THE INVENTION

It is an object of the invention to propose a tuner having an improved selectivity and linearity for converting a RF signal into an IF signal.

To this end, the tuner according to the invention is characterized in that said processing means comprise:

a voltage follower circuit receiving said first IF signal for generating a second IF signal at a low impedance,

control means for controlling the value of the bias current of said voltage follower circuit,

a filter having the double resonance frequency for filtering said second IF signal and generating said IF output signal.

The tuner according to the invention comprises processing means which are based on the use of a filter having a double resonance frequency with which a high selectivity around the intermediate frequency, typically of the value of about 44 MHz can be obtained. In this way, the frequency residues of channels adjacent to the selected channel are eliminated from the frequency spectrum, even if their level is much higher than the level of the selected channel. The IF output signal is thus exempt from frequency components coming from adjacent channels, which leads to a better quality of the information in the selected channel. The use of a filter having a double resonance frequency not only provides the possibility of filtering in a selective manner but also ensures a very low tilt of the frequency range of the channel to be selected.

The filter having a double resonance frequency is insulated from the mixer by a voltage follower circuit having a low impedance at its output. To cancel the variations of the current through the voltage follower circuit, which variations are caused by the input impedance variations of the filter having the double resonance frequency when the frequency varies, control means are associated with the voltage follower circuit. In this way, the voltage follower circuit is always traversed by a bias current of a constant value, which has the advantage that a regime of linear operation is ensured. The frequency components then exert only a very low relative attenuation on the frequency width of the selected channel, which provides the possibility of envisaging the use of such a tuner for digitally modulated channels.

The tuner according to the invention also has the advantage that it can be used for the conversion of RF signals comprising channels modulated in accordance with an analog technique. Indeed, in this case, the channels are further spaced apart and the tuner according to the invention also provides the possibility of selecting such a channel. The tuner according to the invention is thus suitable for mixed usage, which is advantageous when the RF signals are sometimes modulated in accordance with a digital technique and sometimes in accordance with an analog technique, because one tuner suffices.

The invention is also characterized in that the filter having the double resonance frequency comprises two resonant circuits connected by coupling means.

Such an implementation of the double resonance frequency filter has the advantage that it can regulate the overall selectivity of the filter in a precise manner. Moreover, such a mutual coupling circuit provides the possibility of obtaining a frequency response which is exempt from the secondary lobe which could introduce a poor rejection of frequency components coming from adjacent channels.

The invention is also characterized in that the coupling means comprise a capacitive coupling.

The use of a capacitive coupling in the double resonance frequency filter leads to a less costly solution.

The invention also relates to a set-top box implementing a tuner having the characteristic features described above and allowing the conversion of a RF signal into an IF signal.

The invention also relates to a television apparatus which uses a tuner having the characteristic features described above and allows the conversion of a RF signal into an IF signal.

### BRIEF DESCRIPTION OF THE DRAWINGS

These and other aspects of the invention are apparent from and will be elucidated, by way of non-limitative example, with reference to the embodiment(s) described hereinafter.

In the drawings:

FIG. 1 describes the different functional blocks of a tuner known from the prior art,

FIG. 2 describes the arrangement of the different processing means according to the invention for filtering an IF signal,

FIG. 3 describes a first embodiment of the processing means according to the invention for filtering an IF signal,

FIG. 4 describes a second embodiment of the processing means according to the invention for filtering an IF signal,

FIG. 5 describes an embodiment of the control means according to the invention,

FIG. 6 represents the frequency response of a filter having a double resonance frequency according to the invention,

FIG. 7 represents the input impedance variations of the double resonance frequency filter according to the invention,

FIG. 8 illustrates a use of a tuner according to the invention.

### DESCRIPTION OF EMBODIMENTS

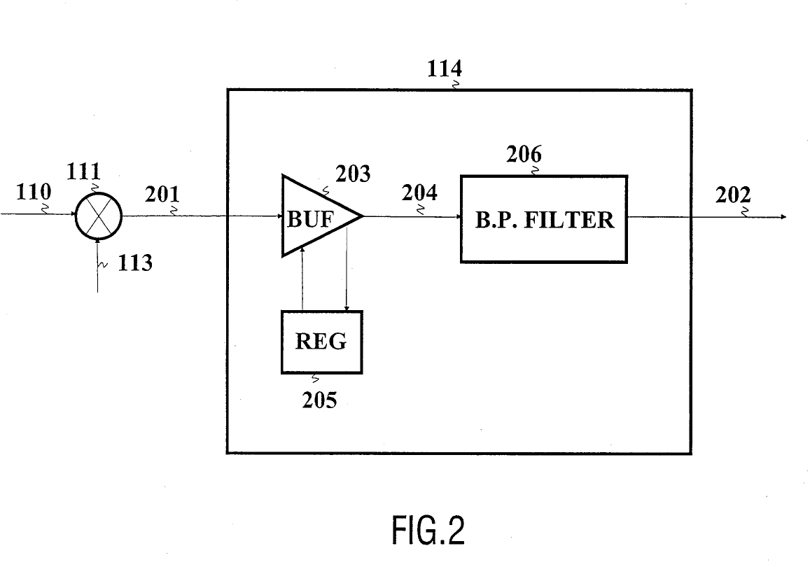

FIG. 2 describes the arrangement of the different processing means 114 according to the invention for filtering a first IF signal 201 and supplying a second IF output signal 202.

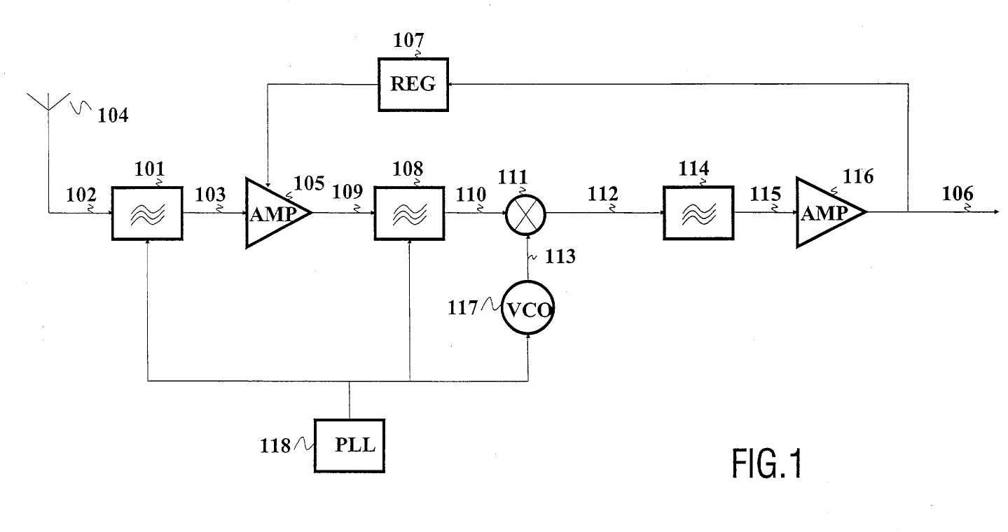

The processing means 114 receive the first IF signal 201 generated by the mixer 111 as described with reference to FIG. 1. First, a voltage follower circuit 203 receives the IF signal 201 and supplies a second IF signal 204 having a low impedance. Control means 205 associated with said circuit 203 allow control of the bias current of the voltage follower circuit so as to ensure a linear operation of the elements constituting said circuit. Secondly, said second IF signal 204 is filtered by means of a filter 206 having a double resonance frequency, generating said IF output signal 202. By its selective characteristics, the filter 206 allows elimination in the signal 204 of the residual frequency components coming from channels adjacent to the selected frequency channel.

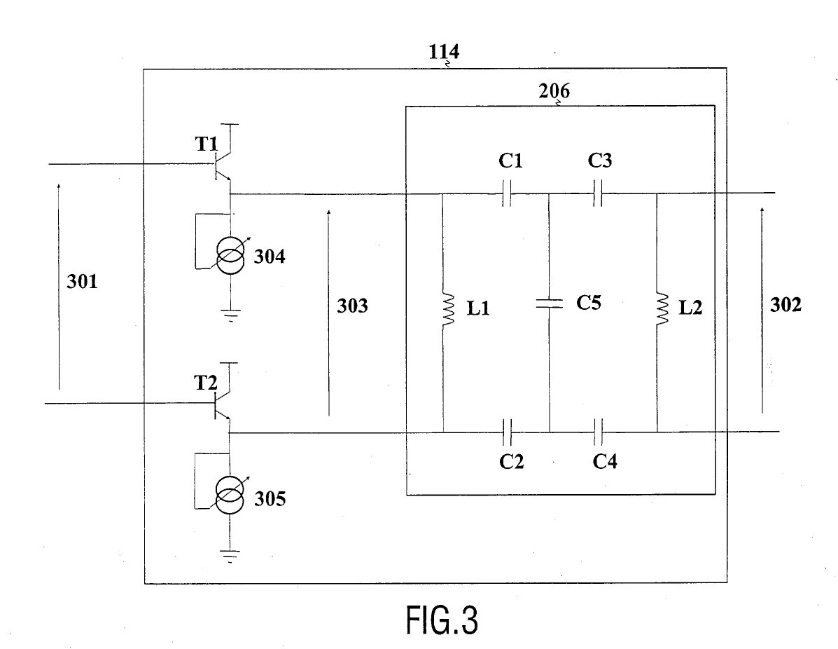

FIG. 3 shows a first embodiment of the processing means according to the invention for filtering a first IF signal 301 and supplying a second IF output signal 302.

In so far as the signal 301 is a differential signal without reference to a particular potential, the input of the voltage follower circuit is constituted by the bases of two transistors T1 and T2. The transistors T1 and T2 are arranged in an emitter follower configuration for supplying a differential signal 303 of a low impedance via their emitters. The emitters of the transistors T1 and T2 are connected to variable current sources 304 and 305 which allow supply of an emitter current of a constant value regardless of the input impedance variations of the double resonance frequency filter 206 receiving said differential signal 303. To ensure this current control, the current sources 304 and 305 are associated with control means described hereinafter.

The double resonance frequency filter 206 is constituted by a first and a second resonant circuit communicating via a capacitive coupling.

The first resonant circuit is constituted by capacitances C1-C2 and the inductance L1. These elements define a first resonance frequency f1 whose value also depends on the characteristics of the second resonant circuit.

The second resonant circuit is constituted by capacitances C3-C4 and the inductance L2. These elements define a second resonance frequency f2 whose value also depends on the characteristics of the first resonant circuit.

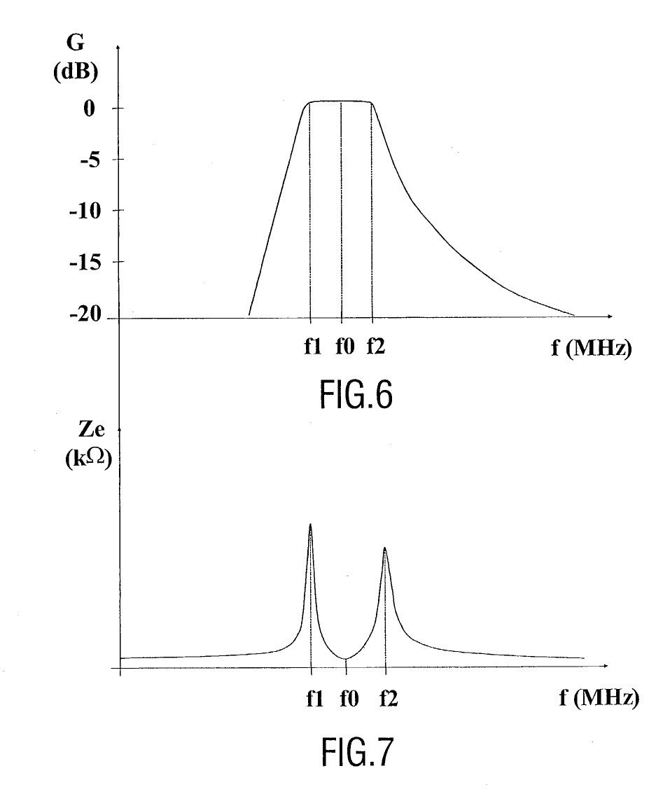

The coupling between the two resonant circuits is effected by means of the capacitance C5. A control of the frequencies f1 and f2 by those skilled in the art provides the possibility of obtaining a frequency response of the double resonance frequency filter as illustrated in FIG. 6. This frequency response is characterized in particular by a zone of very low gain variation G around the intermediate frequency f0, particularly in the frequency interval [f1,f2], which is due to the mutual interaction of the first and second resonant circuits. Moreover, the frequency response outside this central zone is rapidly attenuated, demonstrating the strong selective character of such a filter.

For obtaining a frequency response as that in FIG. 6, those skilled in the art can fix the values of the components of one of the resonant circuits and vary the values of the components of the other circuit until a uniform frequency response around the frequency f0 is obtained.

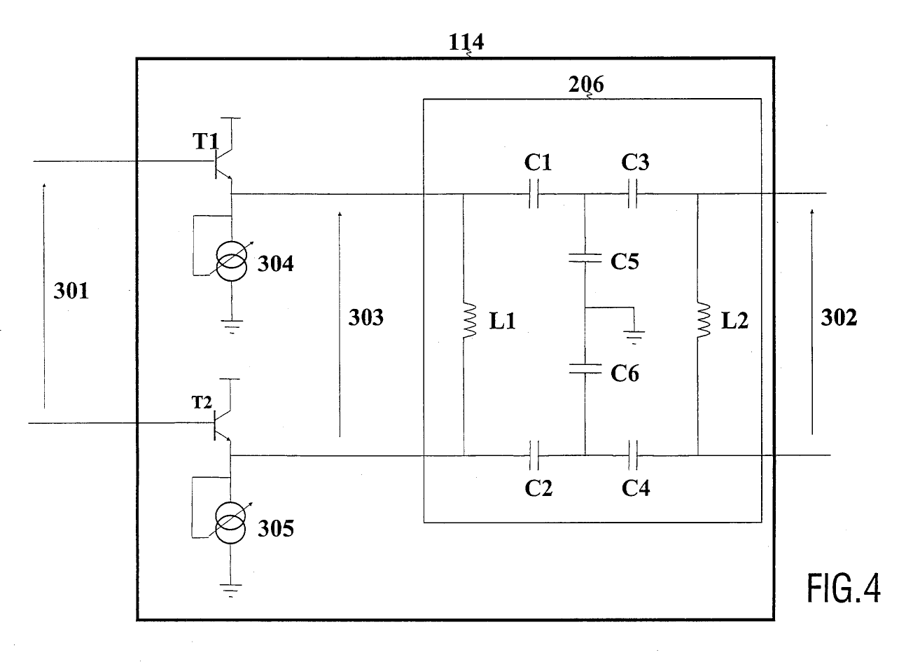

FIG. 4 describes a second embodiment of the processing means according to the invention for filtering a first IF signal 301 and supplying a second IF output signal 302.

This embodiment differs from that in FIG. 3 in that the capacitive coupling of said first and second resonant circuits is constituted by the series arrangement of capacitors C5-C6 and whose central point is connected to ground. This configuration of the capacitive coupling allows an improvement of the common-mode rejection of the signal 303 to be filtered.

As mentioned hereinbefore, the voltage follower circuit is associated with control means for maintaining the bias current in the elements constituting said circuit at a constant value. As is illustrated in FIG. 7, the input impedance Ze of the double resonance frequency filter 206 has a considerable variation in the frequency interval [f1,f2], i.e. in the selective zone of the filter. Indeed, the input impedance of the filter takes low values for frequencies which are situated around the intermediate frequency f0, and high values for frequencies situated around the extremities of the frequency interval [f1,f2]. Particularly, the impedance Ze has a minimum for the frequency f0 and maxima for the frequencies f1 and f2. Consequently, for the same level of said first IF signal 301, the current Iout absorbed by the double resonance frequency filter varies equally strongly in the frequency interval [f1,f2]. As the input current lout of the filter is supplied by the voltage follower circuit constituted particularly by the transistors T1 and T2, for preventing these variations of the current Iout from entailing emitter current variations (and consequently of the base current) in the transistors T1 and T2, the control means are associated with the transistors T1 and T2 in such a way that the emitter current IE of the transistors T1 and T2 observes a constant value regardless of the variations of the current Iout.

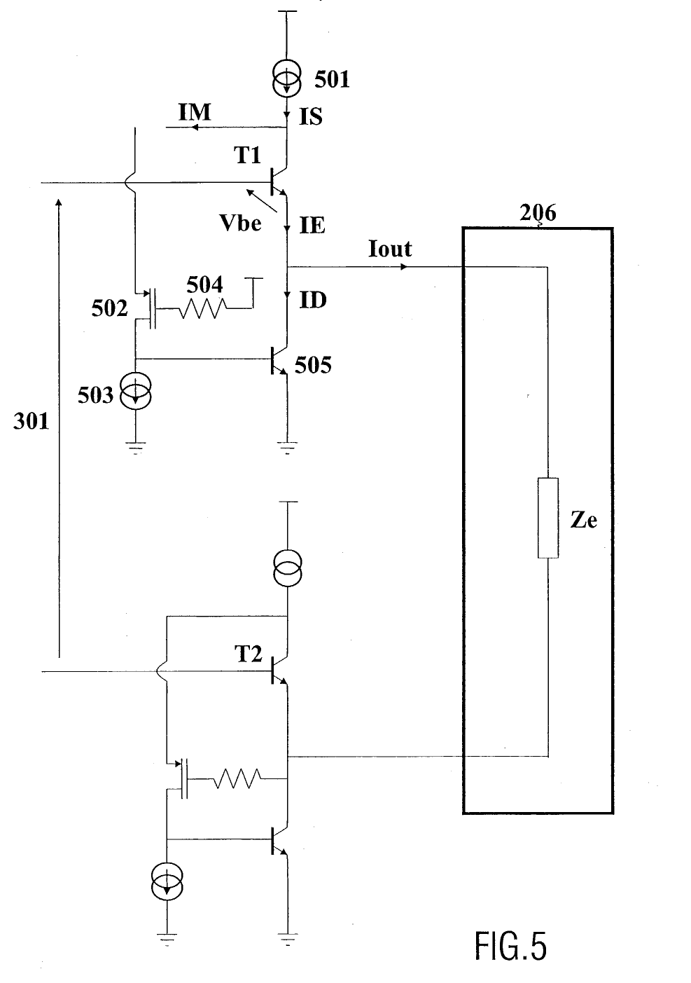

FIG. 5 describes an embodiment of said control means according to the invention. As the first IF signal 301 is a differential signal, identical control means are associated with transistor T1 and transistor T2. Only the control means associated with transistor T1 will be described.

The control means are composed of a current source 501 having a constant value IS, a transistor 502, a current source 503, a resistor 504 and a transistor 505. When the current Iout increases, it tends to entail an increase of the current IE, which tends to entail a diminution of the current IM in so far as the current IS is constant. Via the elements 502-503, this diminution of the current IM entails a diminution of the current ID, thus bringing IE to its constant balanced value. By varying the current ID, this control thus allows the sum of the currents IE=(Iout+ID) to be maintained at a constant value. The base current of the transistor T1 also observes a constant value regardless of the variations of the current Iout, which allows T1 to have a dynamic constant resistance in the base emitter junction. In other words, the base emitter voltage Vbe of the transistor T1 remains constant.

In this way, the voltage follower circuit constituted by the transistor T1 associated with the control means described hereinbefore allows a unitary gain to be obtained for the whole spectrum of the selected frequency channel.

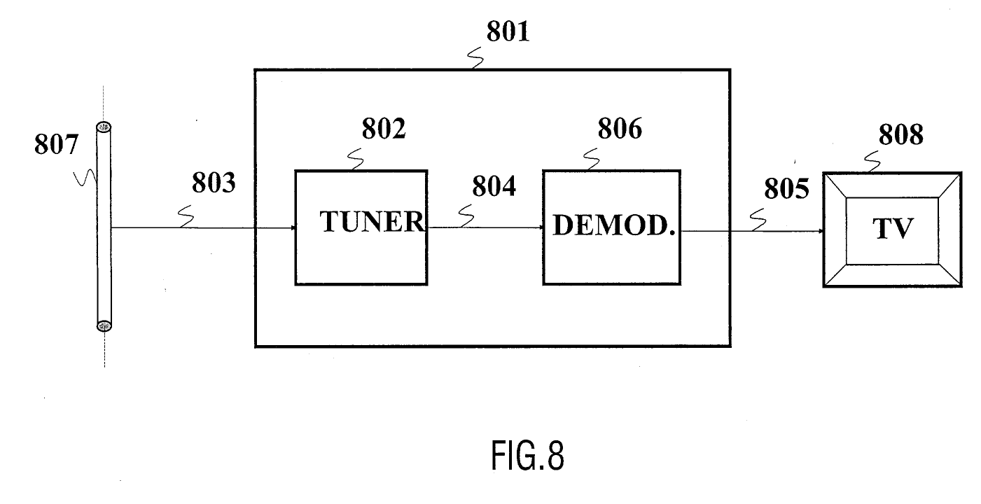

FIG. 8 illustrates an apparatus 801 using a tuner 802 as described in FIG. 1, implementing the characteristic features according to the invention as described with reference to FIGS. 2, 3, 4 and 5. This apparatus is dedicated to the reception of a RF signal 803, its conversion into an IF signal 804, and to the demodulation of the signal 804 for generating the demodulated output signal 805 via the demodulation means 806. In so far as the RF signal 803 may comprise channels modulated in accordance with an analog technique as well as channels modulated in accordance with a digital technique, the tuner 802 is of the hybrid type.

For example, this apparatus 801 is of the set top box type dedicated to the reception of a RF video signal 803 transmitted via a cable network 807. The IF signal 804 supplied by the tuner according to the invention is notably subsequently amplified and demodulated by the processing means 806 with a view to a visualization of the video content via display means 808.

In another use, the tuner according to the invention is directly integrated in a television set.

From a point of view of implementation, the elements of the tuner according to the invention as described with reference to FIG. 4 may be constituted by components of the “discrete” type or by components of the integrated circuit type. Particularly, the elements of the current-controlled voltage follower circuit may be integrated in an integrated circuit.

The tuner according to the invention is particularly well adapted to the processing of RF signals modulated in accordance with a digital technique of the QAM type in so far as it allows a fine selection of a desired frequency channel, all this while rejecting the frequency components of adjacent channels. Particularly, this type of tuner is adapted to processing RF signals of the DVB type transmitted terrestrially, but also RF signals modulated in accordance with an analog technique.

The invention has been described with reference to a tuner for single conversion in which a single mixer is used for converting a RF signal into an IF signal. The invention may also be used in tuners for multiple conversions using several mixers. In this case, it is sufficient to place the processing means according to the invention described with reference to FIG. 2 at the output of the mixer supplying an IF signal.

It should be noted that the invention is not limited to the embodiments described, and alternatives may be envisaged by those skilled in the art without departing from the scope of the invention. Particularly, a different type of current control of the voltage follower circuit may be envisaged (for example, a control without a feedback loop), as well as the use of an inductive connection in the double resonance frequency filter.

1. A tuner for converting a RF signal into an IF output signal, said tuner comprising a mixer for generating a first IF signal, processing means for filtering said first IF signal so as to generate said IF output signal, characterized in that processing means comprise:
a voltage follower circuit receiving said first IF signal for generating a second IF signal at
a low impedance,
control means for controlling the value of the bias current of said voltage follower circuit,
a filter having the double resonance frequency for filtering said second IF signal and generating said IF output signal.

2. A tuner as claimed in claim 1, characterized in that the filter having the double resonance frequency comprises two resonant circuits connected by coupling means.

3. A tuner as claimed in claim 2, characterized in that said coupling means comprise a capacitive coupling.

4. A set-top box for receiving and converting a RF signal into an IF output signal, characterized in that it comprises a tuner as claimed in claim 1.

5. A television apparatus, characterized in that it comprises a tuner as claimed in claim 1.
